(19) United States
(12) Patent Application Publication
(10) Pub. No.: US 2008/0049812 A1
(43) Pub. Date: Feb. 28, 2008

(54) Thermometer with Dual Thermal Sensor

(75) Inventor: Chu Yih Yu, San Chung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MESURE TECHNOLOGY CO., LTD., San Chung City (TW)

(21) Appl. No.: 11/466,186

(22) Filed: Aug. 22, 2006

(51) Int. Cl. G01K 7/00

(52) U.S. Cl. 374/163

(57) ABSTRACT

A thermometer includes a tip member with a thermal contact surface and a first thermal sensor disposed therein for sensing the temperature thereof and producing a first temperature signal. A probe member secured to the tip member includes a front end portion with a thermal compensation point and a second thermal sensor is disposed within the front end portion for sensing the temperature of the thermal compensation point and producing a second temperature signal. A processing unit, disposed within the probe member for receiving the first and second temperature signal, selects a thermal compensation value corresponding to the second temperature signal at a rate of temperature change of the first temperature signal lower than a predetermined value. The thermal compensation value is adapted to compensate the first temperature signal thereby producing an estimated temperature value. And a display unit displays a temperature reading based on the estimated temperature value.

### BACKGROUND OF THE INVENTION

1. Field of the Invention

The invention relates to the field of thermometers. More particularly, the invention relates to the field of medical thermometers employing dual thermal sensor for measurement of a patient's temperature, although it is equally applicable to other temperature measurement fields.

2. Description of the Related Art

Electronic thermometers offer a great number of advantages over conventional glass and mercury thermometer for use in the health care field. Among the advantages of electronic thermometers are the elimination of sterilization procedure for glass thermometers, a digital temperature display to eliminate temperature reading errors, and higher accuracy and resolution, e.g., 1/10 degree Fahrenheit, being easily attainable with proper circuit design and calibration.

However, the major concern with regard to the electronic thermometers lays on their slow time response. This problem is incurred mainly because a thermometer probe including a display portion, made of plastic or rubber, represents a certain amount of mass and heat capacity, and when inserted from room temperature into a body cavity it cannot change temperature instantaneously, but instead approaches its final temperature more or less exponentially. It often requires over three minutes lag time before a final stabilized temperature is measured.

For the purpose of time response reduction, prior art techniques have included using a thermometer probe that has a metal tip for higher heat conductance. Additionally, U.S. Pat. No. 4,183,248 discloses an electronic thermometer which comprises two temperature sensors and a heater coil. The heater coil is used to thermally isolate the metal tip from the remainder of the probe, which eliminates long thermal time delays. The patent claims that a remarkable improvement of about 16 seconds measurement time is accomplished. U.S. Pat. No. 5,632,555 employs a heater to bring the metal tip to a specific temperature before it is applied to a patient. A microprocessing unit using a prediction algorithm is provided to determine the final temperature. This patent claims a measurement time of approximately 4 to 15 seconds.

Nevertheless, these thermometers have some drawbacks such as high energy consumption, since they have a built-in heater to prevent heat from continuously flowing into the probe.

### SUMMARY OF THE INVENTION

An exemplary embodiment of the present invention overcomes the above-described problems by providing a thermometer with dual thermal sensor. The thermometer includes a tip member with a thermal contact surface and a first thermal sensor disposed therein for sensing the temperature of the thermal contact surface and producing a first temperature signal. A probe member secured to the tip member includes a front end portion with a thermal compensation point and a second thermal sensor is disposed within the front end portion for sensing the temperature of the thermal compensation point and producing a second temperature signal. And a processing unit, disposed within the probe member for receiving the first and second temperature signal, selects a thermal compensation value corresponding to the second temperature signal at a rate of temperature change of the first temperature signal lower than a predetermined value. The thermal compensation value is adapted to compensate the first temperature signal thereby rapidly producing an estimated temperature value. And a display unit displays a temperature reading based on the estimated temperature value.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a cross-sectional view of a thermometer pertaining to an exemplary embodiment of the invention;

FIG. 2 is a graph depicting temperature response of dual thermal sensor versus time characteristic for the thermometer of FIG. 1; and

FIG. 3 is a diagram illustrating heat flows in the thermometer of FIG. 1.

### DETAILED DESCRIPTION OF THE INVENTION

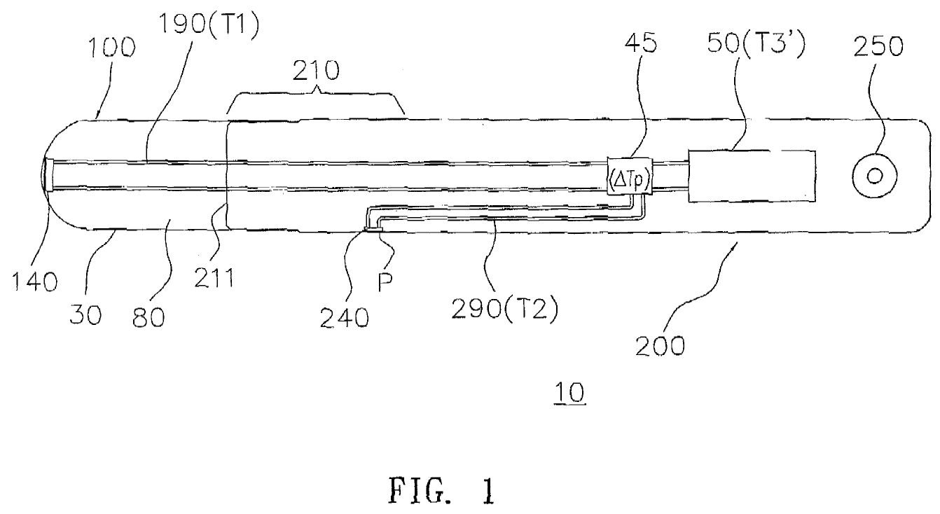

Referring to FIGS. 1-3, an embodiment of a thermometer 10 is illustrated. Thermometer 10 is made up of a probe member 200 with higher heat capacity and a metal tip member 100 with lower heat capacity secured thereto. Preferably, a recess is defined in the outer surface of the probe member's front end portion 210. The back end portion of the tip member 100 has its inner surface adapted to receive the recess of the probe member 200 for formation of a lap joint.

Furthermore, probe member 200 may be extended outwardly from a case with a display portion. Metal tip member 100, preferably, contains a thermal contact surface 30 surrounding a hollow cavity 80. In one embodiment, metal tip member 100 is made of metal with high thermal conductivity, such as stainless steel.

A wide variety of materials are suitable for the probe member 200, such as plastic or rubber, with low thermal conductivity. A first thermal sensor 140 is placed at the end of metal tip member 100 and mounted on the inside of the thermal contact surface 30. First thermal sensor 140 senses the temperature of the thermal contact surface 30 and produces a first temperature signal T1. There are a set of lead wires 190 coupled to first thermal sensor 140 for transmission of the first temperature signal T1.

In one example, metal tip member 100 is made in the form of a tubular shape and closed at a domed, hemispherical or hemiellipsoid shaped end. The thermal contact surface 30 of metal tip member 100 is brought in contact with flesh of a patient so that heat can be transferred from the patient's flesh to metal tip member 100. In one embodiment, first thermal sensor 140 is thermistor. Both lead wires 190 and thermistor 140 are preferably adhered on the inside of the thermal contact surface 30 with heat conductive glue. Moreover, lead wires 190 are made up of a pair of electrical lead wires; they are used to connect the first thermal sensor 140 to a processing unit 45.

The features of the embodiment will now be described therein. Front end portion 210 of the probe member 200 comprises a temperature compensation point P near metal tip member 100. A distance between a front end surface 211 of the front end portion 210 and the temperature compensation point P should be shorter for accuracy of compensation and quick time response. Preferably, the distance is less than about 3 cm and most preferably less than about 1.5 cm.

A second thermal sensor 240 is preferably disposed within front end portion 210 of the probe member 200 for sensing the temperature of the thermal compensation point P and producing a second temperature signal T2. For example, the second thermal sensor 240 may be embedded in or mounted on an inner wall of front end portion 210. There are a set of lead wires 290 coupled to second thermal sensor 240 for transmission of the second temperature signal T2.

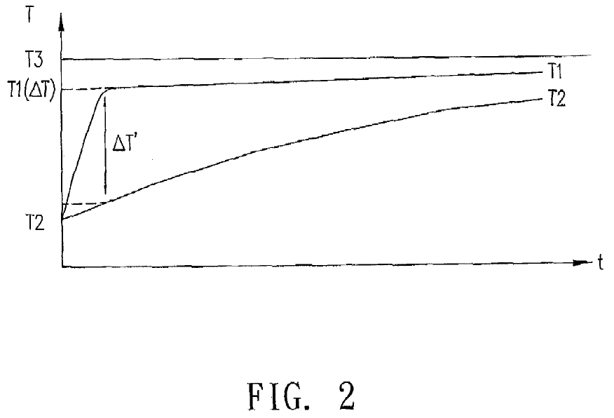

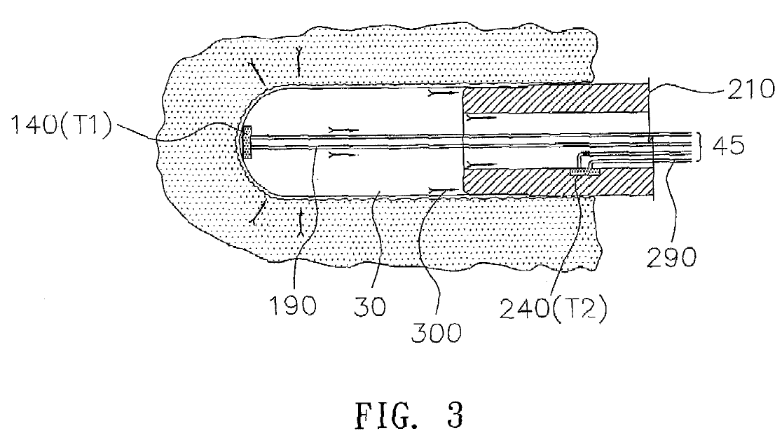

Referring to FIG. 2, during an initial period for sensing the temperature of the thermal contact surface 30, the first temperature signal T1 sensed by first thermal sensor 140 can rise rapidly due to the lower heat capacity and the quick time response of the tip member 100. On the contrary, the second temperature signal T2 sensed by second thermal sensor 240 rises slowly due to the higher heat capacity and the slow time response of the probe member 200. After that, however, the first temperature signal T1 may need more time to approach its final temperature T3 although the first temperature signal T1 can rapidly achieve a rate of temperature change lower than a predetermined value ΔT such as 0.03° C./sec or about 0.3° C./sec. This is because there is a temperature difference ΔT′ between the first and second temperature signal and thus heat from the tip member 100 with lower heat capacity is continuously transferred to the probe member 200 with higher heat capacity along a heat flow path 300 as shown in FIG. 3. Typically, it often requires over three or four minutes lag time before the final stabilized temperature is measured.

Turning now to FIG. 1, a processing unit 45 is preferably disposed within the probe member 200 for receiving the first and second temperature signal T1 and T2. For example, a first set of transmission wires 190 can be connected to the first thermal sensor 140 for passing the first temperature signal T1 to the processing unit 45. And a second set of transmission wires 290 can be connected to the second thermal sensor 240 for passing the second temperature signal T2 to the processing unit 45.

In this case, the processing unit 45 can select a thermal compensation value ΔTp corresponding to the second temperature signal T2 at a rate of temperature change of the first temperature signal T1 lower than a predetermined value ΔT such as 0.03° C./sec or about 0.3° C./sec. And then, the thermal compensation value ΔTp is adapted to compensate the first temperature signal T1 thereby rapidly producing an estimated temperature value T3′ closely to the final stabilized temperature T3.

Next, a display unit 50 is mounted on a display portion of the probe member 200. A set of transmission wires is provided to connect the processing unit 45 to the display unit 50 for displaying a temperature reading based on the estimated temperature value T3′. The thermometer 10 also comprises a switch 250 to turn on and off the display unit 50.

In one example, the processing unit 45 may further comprises or couples to a memory unit, such as ROM, flash memory or EEPROM, for storing corresponding thermal compensation values ΔTp based on the second temperature signal T2 at a rate of temperature change of the first temperature signal T1 lower than a predetermined value ΔT. In general, its compensation weight w % is related to mass and heat capacity of the probe member. For example, as the second temperature signal T2 rises slowly to a lower value due to its higher heat capacity, its compensation weight w % is higher and the needed thermal compensation values is more. The estimated temperature value T3′ are derived using the following formula.

ΔTp=T2*w%

T3′=T1(ΔT)+ΔTp

In this way, the temperature reading based on the estimated temperature value T3′, instead of the final stabilized temperature T3, can be displayed more quickly.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A thermometer with dual thermal sensor comprising:
a tip member with lower heat capacity, comprising a thermal contact surface;
a first thermal sensor, disposed within the tip member for sensing the temperature of the thermal contact surface and producing a first temperature signal;
a probe member with higher heat capacity, comprising a front end portion with a thermal compensation point, secured to the tip member;
a second thermal sensor, disposed within the front end portion of the probe member for sensing the temperature of the thermal compensation point and producing a second temperature signal;
a processing unit, disposed within the probe member for receiving the first and second temperature signal, wherein the processing unit selects a thermal compensation value, corresponding to the second temperature signal at a rate of temperature change of the first temperature signal lower than a predetermined value, to compensate the first temperature signal for rapidly producing an estimated temperature value; and
a display unit, displaying a temperature reading based on the estimated temperature value.

2. The thermometer as recited in claim 1 wherein the tip member is made of metal with high thermal conductivity.

3. The thermometer as recited in claim 2 wherein the probe member is made of plastic or rubber with low thermal conductivity.

4. The thermometer as recited in claim 1 wherein a distance between a front end surface of the front end portion and the thermal compensation point is less than about 3 cm.

5. The thermometer as recited in claim 1 wherein a distance between a front end surface of the front end portion and the thermal compensation point is less than about 1.5 cm.

6. The thermometer as recited in claim 1 wherein the processing unit comprises a memory unit for storing corresponding thermal compensation values based on the second temperature signal at the rate of temperature change of the first temperature signal lower than the predetermined value.

7. The thermometer as recited in claim 1 wherein the processing unit couples to a memory unit for storing corresponding thermal compensation values based on the second temperature signal at the rate of temperature change of the first temperature signal lower than the predetermined value.

8. The thermometer as recited in claim 6 wherein the memory is ROM, flash memory or EEPROM.

9. The thermometer as recited in claim 7 wherein the memory is ROM, flash memory or EEPROM.

10. The thermometer as recited in claim 1 wherein the predetermined value is about 0.03° C./sec or about 0.3° C./sec.

11. The thermometer as recited in claim 1 further comprising:
a first set of transmission wires connected to the first thermal sensor for passing the first temperature signal to the processing unit; and
a second set of transmission wires connected to the second thermal sensor for passing the second temperature signal to the processing unit.

12. The thermometer as recited in claim 1 wherein the second thermal sensor is embedded in an inner wall of the front end portion.

13. The thermometer as recited in claim 1 wherein the second thermal sensor is mounted on an inner wall of the front end portion.
